(19) United States
(12) Patent Application Publication
(10) Pub. No.: US 2013/0292963 A1
(43) Pub. Date: Nov. 7, 2013

(54) PROTECTIVE VEHICLE COVER

(71) Applicant: Danny Carabajal, Garden City, KS (US)

(72) Inventor: Danny Carabajal, Garden City, KS (US)

(21) Appl. No.: 13/461,653

(22) Filed: May 1, 2012

(51) Int. Cl. B60J 11/04

(52) U.S. Cl. 296/136.07

(57) ABSTRACT

The present invention is a protective vehicle cover that includes a base cover that covers an entire vehicle, a top portion that protects a top portion of the vehicle being protected, a driver's side portion that is adjacent to one side of the top portion, a front portion that is adjacent to the top portion and a passenger side portion that is adjacent to the second side of the pair of sides. The protective vehicle cover also includes a rear portion that is adjacent to the top portion, a plurality of hooks that are extended from the sides, front and rear of the top portion, a plurality of adjustable straps that have a pair of distal end that a pair of the hooks are each disposed on and a pump inlet aperture that receives pumped air from an air pump that inflates the protective vehicle cover.

### TECHNICAL FIELD & BACKGROUND

In certain areas where hail is prevalent during the winter months, individuals often suffer extensive damage to their vehicles from hail. The cost to repair the hail damage can be very high, notwithstanding the amount of time the affected vehicle owner may be without the vehicle during the repairs.

The present invention generally relates to a protective cover. More specifically, the invention is a protective vehicle cover.

It is an object of the invention to provide a protective vehicle cover that protects a vehicle from hail during a hail storm.

It is an object of the invention to provide a protective vehicle cover that forms a relatively easily and quickly inflatable blanket over a vehicle.

It is an object of the invention to provide a protective vehicle cover that is relatively easily strapped down onto a vehicle to be protected.

What is really needed is a protective vehicle cover that protects a vehicle from hail during a hail storm that forms a relatively easily and quickly inflatable blanket over a vehicle is relatively easily strapped down onto a vehicle to be protected.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a front view of a protective vehicle cover, according to an embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

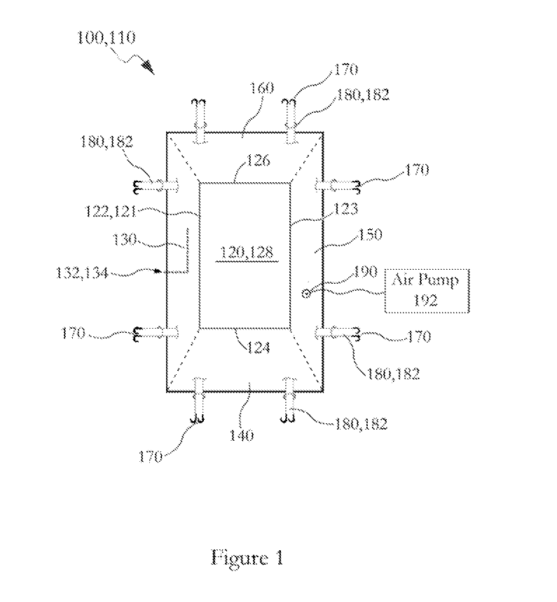

FIG. 1 illustrates a front view of a protective vehicle cover 100, according to an embodiment of the present invention. The protective vehicle cover 100 is utilized to typically protect a vehicle from hail during a hail storm but can be utilized to perform other suitable protective purposes.

The protective vehicle cover 100 includes a base cover 110, a top portion 120, a driver's side portion 130, a front portion 140, a passenger side 150, a rear portion 160, a plurality of hooks 170, a plurality of adjustable straps 180 and a pump inlet aperture 190. The base cover 110 covers the entire vehicle being protected by the protective vehicle cover 100. The base cover 110 is made of canvas material but can be made of other suitable material as well. The top portion 120 has a pair of sides 122 that include a first side 121 and a second side 123, a front 124, a rear 126 and a generally rectangular shape 128 and protects a top portion of the vehicle being protected. The driver's side portion 130 is adjacent to one side 122 of the pair of sides 122 of the top portion 120. A zipper 132 is disposed on the driver's side portion 130 to allow access to the driver's side of the vehicle being protected. The zipper 132 is inverted L-shaped 134 but can be any suitable shape. The front portion 140 is adjacent to the front 124 of the top portion 120 of the vehicle being protected. The passenger side portion 150 is adjacent to the other side 122 of the pair of sides 122 of the top portion 120. The rear portion 160 is adjacent to the rear 126 of the top portion 120 and protects the rear of the vehicle. The hooks 170 are extended from the pair of sides 122, the front 124 and the rear 126 of the top portion 120. The hooks 170 include 2 single pronged hooks but can include any suitable number or type of hooks. The adjustable straps 180 have a distal end 182 that a pair of the hooks 170 is disposed on. The pump inlet aperture 190 is disposed inside on the driver's side portion 130 and receives pumped air from an air pump 192 that inflates the protective vehicle cover 100. The protective vehicle cover 100 is inflated approximately 3 inches in height to protect the vehicle utilizing the protective vehicle cover 100.

Made of a canvas material capable of effectively preventing hail damage, the protective vehicle cover is an alternative to similar traditional products. The protective vehicle cover is relatively easy to use, where a user simply drapes the protective vehicle cover over the vehicle and utilizes the provided plurality of straps with a plurality of adjustable hooks located throughout to successfully cover the vehicle. Once the vehicle has been entirely covered, the user inflates the protective vehicle cover through an inlet aperture allowing pumped air to raise the protective vehicle cover approximately three inches. Among those who will find the protective vehicle cover both convenient and practical are car accessory manufacturers as well as an everyday consumer. The protective vehicle cover features an inflatable canvas material that is provided with a plurality of adjustable straps and a plurality of built-in hooks capable of effectively eliminating or reducing hail damage on a vehicle. The protective vehicle cover is designed to be inflated utilizing an air pump which is typically powered by a cigarette lighter located in an interior of the protected vehicle but can be powered by any suitable power source.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A protective vehicle cover, comprising:
a base cover that covers an entire vehicle being protected by said protective vehicle cover;
a top portion that has a pair of sides, a front and a rear that protects a top portion of said vehicle being protected;
a driver's side portion that is adjacent to said one side of said pair of sides of said top portion, said driver's side portion includes a zipper to allow access to said drivers side of said vehicle being protected;
a front portion that is adjacent to said front of said top portion of said vehicle being protected;
a passenger side portion that is adjacent to said second side of said pair of sides of said top portion;
a rear portion that is adjacent to said rear of said top portion and protects said rear of said vehicle;
a plurality of hook;
eight adjustable straps that each have a distal end which a pair of said hooks are disposed on, wherein said strap are disposed on said top portion and distributed with two straps on each side, two on said front and two on said rear; and
a pump inlet aperture that receives pumped air from an air pump that inflates said protective vehicle cover, said pump inlet aperture is disposed on said passenger side.

2. The protective vehicle cover according to claim 1, wherein said base cover is made of canvas material.

3. The protective vehicle cover according to claim 1, wherein said top portion has a generally rectangular shape.

4. (canceled)

5. The protective vehicle cover according to claim 1, wherein said hooks include 2 single pronged hooks.

6. (canceled)

7. The protective vehicle cover according to claim 1, wherein said protective vehicle cover is inflated approximately 3 inches.

8. A protective vehicle cover, comprising:
a base cover that covers an entire vehicle being protected by said protective vehicle cover;
a top portion with a generally rectangular shape that has a pair of sides, a front and a rear that protects a top portion of said vehicle being protected;
a driver's side portion that is adjacent to said one side of said pair of sides of said top portion, said driver's side portion includes an inverted L-shaped zipper to allow access to said driver's side of said vehicle being protected;
a front portion that is adjacent to said front of said top portion of said vehicle being protected;
a passenger side portion that is adjacent to said second side of said pair of sides of said top portion;
a rear portion that is adjacent to said rear of said top portion and protects said rear of said vehicle;
a plurality of hooks;
eight adjustable straps that each have a distal end which a pair of said hooks are disposed on, wherein said strap are disposed on said top portion and distributed with two straps on each side, two on said front and two on said rear; and
a pump inlet aperture that is disposed on said driver's side that receives pumped air from an air pump that inflates said protective vehicle cover, said pump inlet aperture is disposed inside said passenger side.

9. The protective vehicle cover according to claim 8, wherein said base cover is made of canvas material.

10. (canceled)

11. The protective vehicle cover according to claim 8, wherein said hooks include 2 single pronged hooks.

12. (canceled)

13. The protective vehicle cover according to claim 8, wherein said protective vehicle cover is inflated approximately 3 inches.

14-20. (canceled)
